(19) United States
(12) Patent Application Publication
(10) Pub. No.: US 2026/0180244 A1
(43) Pub. Date: Jun. 25, 2026

(54) RETENTION CLIP FOR A CABLE TUBE, CONNECTOR AND CONNECTION ASSEMBLY

(71) Applicant: TE Connectivity India Private Limited, Bangalore (IN)

(72) Inventors: Akshaykumar Patil, Bangalore (IN); Danappa Hugar, Bangalore (IN)

(21) Appl. No.: 19/423,718

(22) Filed: Dec. 17, 2025

(30) Foreign Application Priority Data
Dec. 20, 2024 (IN) 202441101300

(51) Int. Cl. H01R 13/58; H01B 7/00; H01R 13/56

(52) U.S. Cl. CPC H01R 13/5812; H01B 7/0045; H01R 13/562

(57) ABSTRACT

A retention clip for mechanical strain relief of a cable tube surrounding a cable harness of a connector defines a cable channel for passing therethrough the cable harness along an insertion direction. The retention clip includes a catch section at least partially projecting into the cable channel and adapted to engage the cable tube inserted into the cable channel, an anchoring section for attachment of the retention clip to the connector, and a transition section located between the anchoring section and the catch section, wherein the transition section continuously surrounds the cable channel and is circumferentially monolithic with respect to the insertion direction. Due to the circumferentially monolithic nature, the retention clip more compact and easier to manufacture and install than existing strain relief structures with two halves. Further, a cable assembly, a connector and a connection assembly with such a retention clip are provided.

### CROSS REFERENCE TO RELATED APPLICATIONS

This application claims the benefit of IN application No. 202441101300, filed 20 Dec. 2025, the subject matter of which is herein incorporated by reference in its entirety.

### BACKGROUND OF THE INVENTION

The subject matter herein relates to a retention clip for mechanical strain relief of a cable tube surrounding a cable harness of a connector. Further, the subject matter herein relates to a cable assembly and a connector with such a retention clip. Moreover, the subject matter herein relates to a connection assembly with such a connector and a complementary connector.

Cables are often installed between spaced-apart technical units in order to transfer power and/or signals. In many applications, separable connections are established between these cables and technical units using connection assemblies. These connection assemblies usually comprise a pair of complementary connectors, such as a plug and a header.

If multiple cables are used together as a cable harness, it is expedient to bundle them with a cable tube. Not only does the cable tube simplify the handling of the cable harness, it also provides additional protection against damage, heat and other kinds of external influences for individual, less robust and delicate cables.

In order to fulfil its functions reliably, the cable tube needs to be securely fastened to the corresponding connector. For this purpose, mechanical strain relief structures are commonly utilized, which receive mechanical loads acting on the cable tube. The mechanical strain relief structures may thus help to avoid an unwanted pull-out of the cable tube from the connector.

Existing strain relief structures usually entail a time-consuming installation process. Therefore, it is desirable for a mechanical strain relief structure to be easily and quickly installable.

### BRIEF DESCRIPTION OF THE INVENTION

In one embodiment, means are provided for facilitating and expediting the implementation of mechanical strain relief for cable tubes.

In an embodiment, a retention clip is provided for mechanical strain relief of a cable tube surrounding a cable harness of a connector, wherein the retention clip defines a cable channel for passing therethrough the cable harness along an insertion direction, wherein the retention clip comprises a catch section at least partially projecting into the cable channel and adapted to engage the cable tube inserted into the cable channel, an anchoring section for attachment of the retention clip to the connector and a transition section located between the anchoring section and the catch section, wherein at least the transition section continuously surrounds the cable channel and is circumferentially monolithic with respect to the insertion direction.

Herein, the catch section represents the mechanical interface with the cable tube, while the anchoring section acts as the mechanical interface with the connector. Once the catch section engages the cable tube and the retention clip is attached to the connector using the anchoring section, a mechanical strain relief for the cable tube is completed. Any pull-out force acting on the cable tube is received by the catch section, and transmitted via the transition section to the connector through the anchoring section.

The transition section is circumferentially monolithic in that it is uninterrupted and continuous in structure without any breaks, joints, or separable parts along a circumferential direction, the circumferential direction being perpendicular to the insertion direction.

This monolithic nature of the transition section brings about the following advantages:

On one hand, the retention clip according to the invention is easy to manufacture and install compared to existing strain relief structures that normally comprise two halves that need to be manufactured and handled separately. On the other hand, the retention clip is compact in its design, since no hinges or buckles that hold together the two halves in existing strain relief structures are required. This all allows the retention clip to be installed easily and quickly.

The above solution may be further improved by adding one or more of the following optional features. Each of the following optional features is advantageous on its own and may be combined independently with any other optional feature.

According to one possible embodiment, the retention clip defines the cable channel in that the retention clip comprises a substantially sleeve-shaped main body with a through opening that forms the cable channel. Through the cable channel, the cable harness can pass along an insertion direction. The respective sections (i.e. catch section, anchoring section and transition section) are part of said main body. Besides the transition section, the catch section and/or the anchoring section may also continuously surround the cable channel and be circumferentially monolithic with respect to the insertion direction.

According to another possible embodiment, the catch section may be adapted to automatically engage the cable tube, once the cable tube has been inserted into the cable channel along the insertion direction. Depending on the application, the cable tube can be inserted into the cable channel and engaged by the catch section, prior to or after the attachment of the retention clip to the connector, thus rendering the installation process more flexible. As will be explained in more detail further below, said engagement between the catch section and cable tube may involve a form-fit, a force-fit or a combination of both.

An easy way of implementing the automatic engagement between the catch section and cable tube, may be to have the catch section comprise at least one latching element configured deflectable away from the cable channel. The at least one latching element may be deflectable in that it is more flexible and springy than the rest of the catch section. In particular, the at least one latching element can initially be deflected by the cable tube being inserted into the cable channel along the insertion direction. Once the cable tube has been inserted to a sufficient depth, the at least one latching element, driven by its elastic restoring force, can be moved back towards the cable channel and into engagement with the cable tube.

According to another possible embodiment, the at least one latching element may comprise protrusion extending into the cable channel radially with respect to the insertion direction. It is with this protrusion that the catch section projects inwardly into the cable channel. In particular, the protrusion may be configured as a serration that bites or digs into the material of the cable tube as part of the above-mentioned combination from force-fit and form-fit.

If a corrugated tube is used as the cable tube, the protrusion may be configured to enter between two neighboring ribs of the corrugated tube to result in the above-mentioned form-fit. For example, the catch section, in particular the protrusion may form a retention surface extending perpendicular to the insertion direction and facing towards the anchoring section. The rib of the corrugated tube that is further inside the cable channel can rest against the retention surface, resulting in said form-fit engagement between the retention clip and the corrugated tube.

In order to facilitate the insertion of the cable tube into the catch section, the catch section, in particular the protrusion may form a lead-in chamfer extending obliquely with respect to the insertion direction. Additionally or alternatively, the lead-in chamfer may face away from the anchoring section. That is, the lead-in chamfer may face towards the cable tube being inserted along the insertion direction and thus fulfils a guiding function.

Optionally, the transition section may comprise a stop surface extending perpendicular to the insertion direction and/or facing away from the anchoring section. The stop surface may be aligned with the protrusion in the insertion direction. That is, the stop surface may at least partially overlap with the protrusion in the insertion direction. Once the inserted cable tube abuts against the stop surface, it is not insertable any further. This prevents the cable tube from sinking too far into the retention clip. Neither the protrusion nor the stop surface hinder the cable harness from passing through the cable channel.

In order to prevent damage to the cable tube, the protrusion may comprise a concavely rounded edge, the edge being located between the lead-in chamfer and the retention surface of the protrusion.

According to another possible embodiment with a simple design, the at least one latching element may comprise a cantilever arm extending along the insertion direction. In particular, the cantilever arm may comprise a proximal end connected to the rest of the catch section and a distal end forming the protrusion. Its arrangement on the distal end of the cantilever arm provides the protrusion with an increased range of motion and thus improved mobility.

Optionally, the cantilever arm may extend towards the anchoring section. That is, the anchoring section may be closer to the distal end of the cantilever arm than to the proximal end of the cantilever arm.

This orientation is advantageous for the following reason: a pull-out force acting on the cable tube and trying to rip it off the retention clip would be directed away from the retention clip and specifically away from the anchoring section. By having the cantilever arm extend towards the anchoring section, the cantilever arm can stem against such a pull-out force and withstand higher loads on the cable tube.

According to another possible embodiment, the retention surface of the protrusion may be offset inwards with respect to the proximal end of the cantilever arm. In other words, the retention surface may be located further inwards than the proximal end of the cantilever arm.

This configuration has the following advantage: the pull-out force acting on the corrugated tube is received by the retention surface via the rib of the corrugated tube. By offsetting the retention surface inwards, the pull-out force causes the cantilever arm to tilt inwards, which would in turn increase the grip of the catch section on the corrugated tube. Hence, the strain relief functions in a self-locking manner.

Optionally, the at least one latching element may comprise a tool engagement portion adapted for receiving a tool tip during removal of the cable tube. In particular, the tool engagement portion may be located between the cantilever arm and the protrusion. There, the tool engagement portion allows the cable tube to be released by deflecting the latching element away from the cable tube.

For increased stability, the catch section may comprise at least two latching elements. The at least two latching elements may be arranged diametrically opposite each other with respect to the cable channel. Optionally, more than two latching elements may be provided and distributed circumferentially around the cable channel. The cantilever arms of these latching elements may extend in parallel.

According to another possible embodiment, the catch section may form a collar with an outward extending flange. Said flange increases the structural stability of the catch section through added stiffness, which allows the retention clip to withstand higher pull-out forces before deforming and giving in. If an adjustment of the cable exit direction is required, angled cable routing means, such as a 90° elbow can be attached to said flange.

In a further embodiment, a cable assembly is provided including a retention clip according to any one of the above-described embodiments, a cable tube and a cable harness. The cable harness may be surrounded at least partially by the cable tube. Further, the cable harness and cable tube may both be passed through the cable channel of the retention clip. Herein, the cable harness may pass through the entire cable channel, while the cable tube at least reaches the catch section, the retention clip may be engaged with the cable tube.

The cable assembly benefits from the technical effects and advantages of the retention clip as explained above, which results in an increased flexibility of work steps during its installation. In particular, the cable assembly can be installed either by first attaching the retention clip to a connector housing and then inserting the cable tube into the cable channel or by inserting the cable tube into the cable channel first and afterwards attaching the clip-and-tube structure to the connector housing. Prior to or after that, the cable harness can be passed through the cable tube and cable channel.

In contrast to this, a conventional cable assembly can be only installed by simultaneously placing the connector housing and the cable tube between the two halves. A consecutive order of the work steps as in the present invention is not possible.

The cable harness may comprise at least one cable, in particular an electrical cable, an optical cable or a cable comprising means for transmitting both electrical and optical signals and/or power. In other words, the applicability of the present invention is not limited to electrical systems, but may also extend e.g., to optical, electrooptical and opto-electronical systems.

Moreover, the initial object is achieved by a connector comprising a cable assembly according to the above-described embodiments and a housing, wherein the retention clip of the cable assembly is attached to the housing by means of its anchoring section.

The connector also benefits from the technical effects and advantages of the retention clip as explained above, which result in improved maintainability. In particular, the cable tube can be released from the catch section (e.g. by deflecting each latching element), without having to remove the retention clip from the housing. Likewise, the whole cable assembly can be detached from the housing without unengaging the retention clip from the cable tube. Advantageously, this allows selective removal of only those components that need to be inspected, repaired or exchanged.

For use in electrical applications, the connector may further comprise at least one electrically conductive contact element for terminating the electrical cable and contacting a mating contact of a complementary connector.

A connection assembly comprising such a connector and a complementary connector also achieves the initial object. Herein, the complementary connector is configured to be mated with the connector along a mating direction. As explained above, the connector is easy to install and service, which equally applies to the connection assembly.

Optionally, the connection assembly may comprise a mating aid adapted for supporting a mating process and/or an unmating process of the connector and complementary connector. For example, the mating aid may be a release mechanism, such as a button, key or push-area, configured to be actuated perpendicular to the mating direction. As such, the mating aid may at least partially extend through the cable channel of the retention clip. Thereby, access to the mating aid can be controlled via the retention clip. Advantageously, the retention clip can be designed not to obstruct the mating aid at all or to restrict the mating aid to be actuated only from a certain direction and/or with a certain tool. In particular, the retention clip, specifically the anchoring section may comprise an access slot through which the release mechanism is accessible for a tool tip or human finger.

In the following, exemplary embodiments of the invention are described with reference to the drawings. The embodiments shown and described are for explanatory purposes only. The combination of features shown in the embodiments may be changed according to the foregoing description. For example, a feature, which is not shown in an embodiment, but described above, may be added if the technical effect associated with this feature is beneficial to a particular application. Vice versa, a feature shown as part of an embodiment may be omitted as described above, if the technical effect associated with this feature is not needed in a particular application.

In the drawings, elements that correspond to each other with respect to function and/or structure have been provided with the same reference numeral.

### BRIEF DESCRIPTION OF THE DRAWINGS

FIG. 1 shows a schematic illustration of a perspective view of a retention clip according to one possible embodiment of the present disclosure;

FIG. 2 shows a schematic illustration of another perspective view of the retention clip from FIG. 1;

FIG. 3 shows a schematic illustration of a sectional side view of the retention clip from FIG. 1 cut along the sectional plane III-III;

FIG. 4 shows a schematic illustration of another sectional side view of the retention clip from FIG. 1 cut along the sectional plane IV-IV;

FIG. 5 shows a schematic illustration of a sectional side view of a cable assembly according to one possible embodiment of the present disclosure;

FIG. 6 shows a schematic illustration of a sectional side view of the cable assembly according to another possible embodiment of the present disclosure

FIG. 7 shows a schematic illustration of an exploded, perspective view of a connector according to one possible embodiment of the present disclosure;

FIG. 8 shows a schematic illustration of a perspective view of the connector from FIG. 7; and

FIG. 9 shows a schematic illustration of a perspective view of a connection assembly according to one possible embodiment of the present disclosure.

### DETAILED DESCRIPTION OF THE INVENTION

In the following, the structure of possible embodiments of a retention clip 1, a cable assembly 2, a connector 4 and a connection assembly 6 is explained with reference to the exemplary embodiments shown in FIGS. 1 to 9.

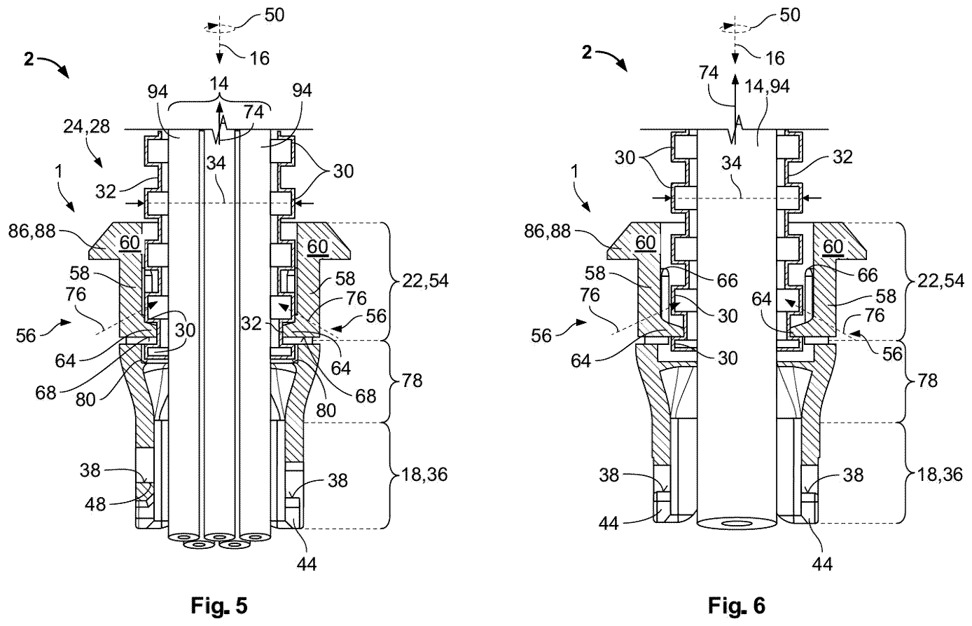

FIG. 1 shows a perspective view of the retention clip 1 according to one possible embodiment of the present disclosure. The retention clip 1 may be an injection-molded or 3D-printed piece made of plastic material. As can be seen, the retention clip 1 may comprise a substantially sleeve-shaped or tubular main body 8 with a through opening that forms a cable channel 12. The cable channel 12 mainly serves for passing there through a cable harness 14 (see FIGS. 5 and 6) along an insertion direction 16. According to an alternative embodiment, the retention clip 1 may also be a stamped and bent piece made out of a metal pipe (not shown).

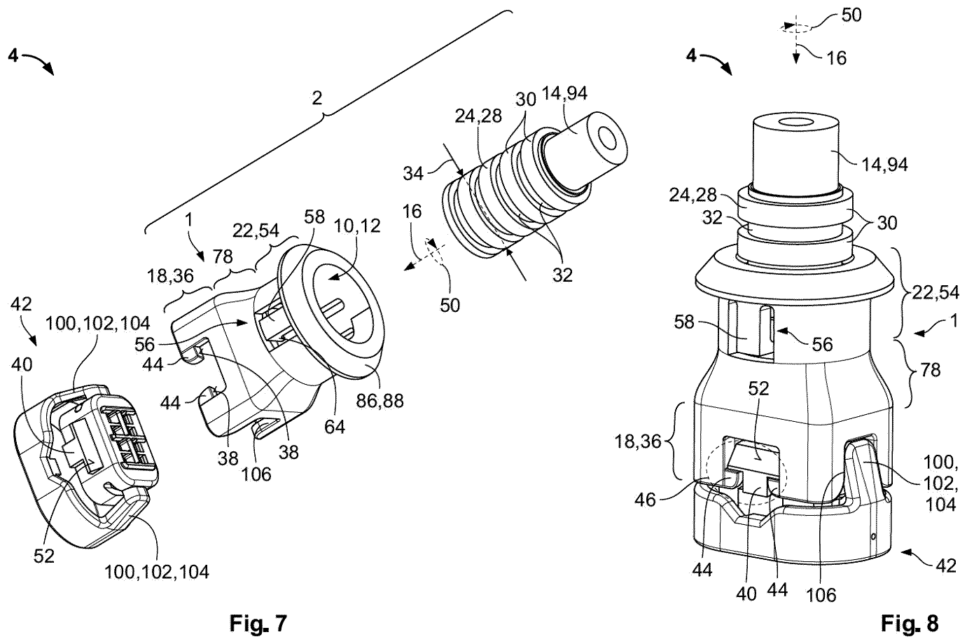

As is shown in FIGS. 7 and 8, the retention clip 1 functions as a mechanical interface 18 with the connector 4 on one side 20, and as a mechanical interface 22 with a cable tube 24 on the other side 26, the sides 20, 26 being aligned along the insertion direction 16. This way, the retention clip 1 can act as mechanical strain relief of the cable tube 24 surrounding the cable harness 14.

As shown in FIGS. 5 to 8, the cable tube 24 may be a corrugated tube 28 comprising a series of radial ribs 30 and radial grooves 32 arranged alternatingly along the insertion direction 16. The radial ribs 30 may have a common outer diameter 34 measured perpendicularly with respect to the insertion direction 16.

The above-mentioned mechanical interface 18 with the connector 4 is implemented at an anchoring section 36 of the retention clip 1. The anchoring section 36 is part of the main body 8 and serves for attachment of the retention clip 1 to the connector 4. In general, the anchoring section 36 provides at least one undercut surface 38 that can reach behind an anchor point 40 (see FIGS. 7 and 8) of a housing 42 of the connector 4.

As can be seen in FIG. 1, the anchoring section 36 may comprise at least one snap-fit hook 44 extending substantially along the insertion direction 16 towards the connector 4 and forming the undercut surface 38. For example, two such snap-fit hooks 44 may be provided and configured to jointly engage in a snap-fit connection 46 with the anchor point 40 of the connector housing 42.

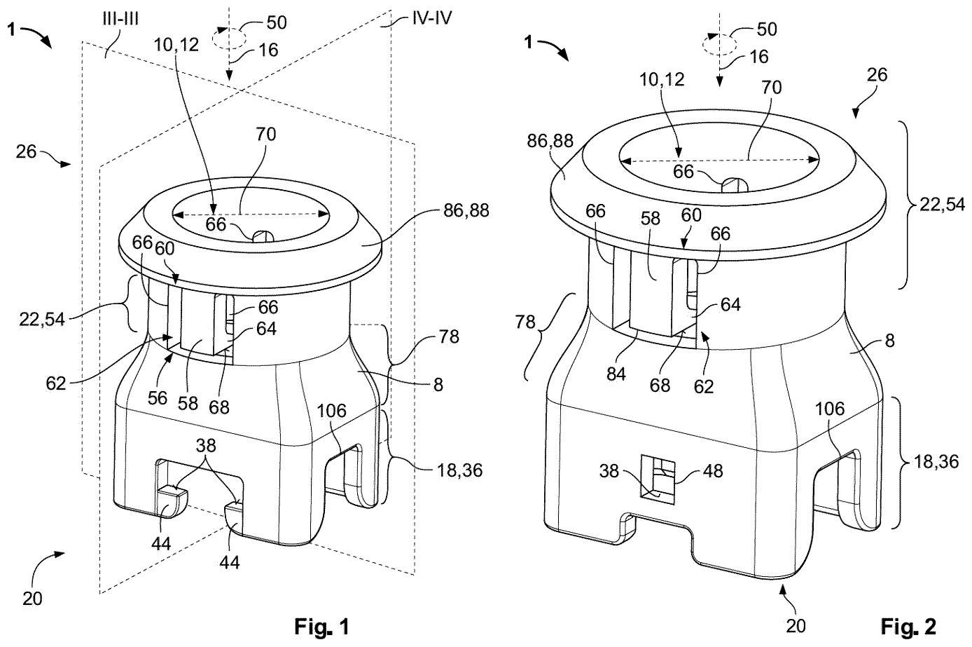

Alternatively or additionally, the anchoring section 36 of the retention clip 1 may comprise at least one snap-fit pocket 48 (see FIG. 2) configured to engage in a snap-fit connection with another anchor point of the connector housing 42. Depending on the number, size, shape and location of the anchor points on the connector housing 42, appropriate snap-fit hooks 44 and snap-fit pockets 48 may be provided at the anchoring section 36 and distributed along a circumferential direction 50 with respect to the insertion direction 16.

For its installation, the retention clip 1 simply needs to be placed onto the housing 42 with its anchoring section 36 first and pressed or pushed along the insertion direction 16, until the snap-fit connection 46 is established. Providing a tapered surface 52 on the respective anchor points 40 facilitates this establishment of the snap-fit connection 46. Moreover, it is expedient to offset the snap-fit hooks 44 from the snap-fit pockets 48 along the insertion direction 16, in order to have them arrive at different timings at the corresponding anchor point and thus lower the required peak force for pressing or pushing the retention clip 1 onto the connector housing 42.

The above-mentioned mechanical interface 22 with the cable tube 24 is implemented at a catch section 54 of the retention clip 1. The catch section 54 is also part of the main body 8 from where it at least partially projects into the cable channel 12. As such, the catch section 54 is adapted to engage the cable tube 24 inserted into the cable channel 12. In particular, the catch section 54 may be adapted to automatically engage the cable tube 24, once the cable tube 24 has been inserted into the cable channel 12 along the insertion direction 16. Said engagement between the catch section 54 and cable tube 24 may involve a form-fit, a force-fit or a combination of both.

This will be explained in more detail below.

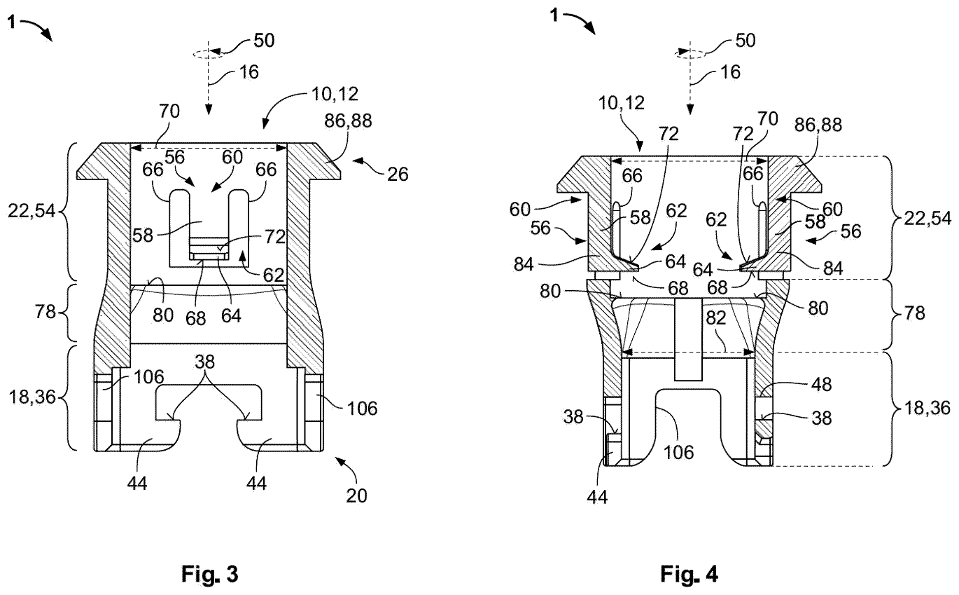

As can be seen in FIG. 3, the catch section 54 may comprise at least one latching element 56 configured deflectable away from the cable channel 12. Herein, the at least one latching element 56 may be deflectable in that it is more flexible and springy than the rest of the catch section 54.

In particular, the at least one latching element 56 may comprise a cantilever arm 58 extending along the insertion direction 16. The cantilever arm 58 may comprise a proximal end 60 connected to the rest of the catch section 54 and a distal end 62 forming a protrusion 64. For increased flexibility, the cantilever arm 58 may be separated from the rest of the catch section 54 by slits 66 that extend through the main body 8 along the insertion direction 16.

The above-mentioned protrusion 64 may extend into the cable channel 12 radially with respect to the insertion direction 16. It is with this protrusion 64 that the catch section 54 projects inwardly into the cable channel 12. For the corrugated tube 28, the protrusion 64 may be configured to enter between two neighboring ribs 30 to result in the above-mentioned form-fit.

In particular, the protrusion 64 may form a retention surface 68 extending perpendicular to the insertion direction 16 and facing towards the anchoring section 36. The radial rib 30 of the corrugated tube 28 that is further inside the cable channel 12 can rest against the retention surface 68, resulting in said form-fit engagement between the retention clip 1 and the corrugated tube 28. Alternatively, the protrusion may be configured as a serration that bites or digs into the material of the cable tube as part of the above-mentioned combination from force-fit and form-fit.

During installation, the protrusion 64 can initially be deflected by the corrugated tube 28 being inserted into the cable channel 12 along the insertion direction 16. Once the corrugated tube 28 has been inserted to a sufficient depth, the protrusion 64, driven by the elastic restoring force of the cantilever arm 58, can be move back towards the cable channel 12 and into engagement with the corrugated tube 28 (as shown in FIGS. 5 and 6).

Apart from the protrusion 64, an inner diameter 70 of the cable channel 12 in the region of the catch section 54 is chosen to be equal to or larger than the outer rib diameter 34 of the corrugated tube 28. To facilitate the insertion of the corrugated tube 28 into the catch section 54, the protrusion 64 may form a lead-in chamfer 72 extending obliquely with respect to the insertion direction Additionally or alternatively, the lead-in chamfer 72 may face away from the anchoring section 36. In other words, the lead-in chamfer 72 fulfils a guiding function by facing towards the corrugated tube 28 being inserted along the insertion direction 16.

As can be seen in FIGS. 4 to 6, the cantilever arm 58 may extend towards the anchoring section 36. That is, the anchoring section 36 may be closer to the distal end 62 of the cantilever arm 58 than to the proximal end 60 of the cantilever arm 58. Hence, a pull-out force 74 acting on the corrugated tube 28 and trying to rip it off the retention clip 1 would be directed away from the retention clip 1 and specifically away from the anchoring section 36. By having the cantilever arm 58 extend towards the anchoring section 36, the cantilever arm 58 can stem against the pull-out force 74 and withstand higher loads on the corrugated tube 28.

As can further be seen in FIGS. 4 to 6, the retention surface 68 of the protrusion 64 may be offset inwards with respect to the proximal end 60 of the cantilever arm 58. In other words, the retention surface 68 may be located further inwards than the proximal end 60 of the cantilever arm 58.

Thereby, a self-locking function can be achieved.

After all, the pull-out force 74 acting on the corrugated tube 28 is received by the retention surface 68 via the rib 30. By offsetting the retention surface 68 inwards, the pull-out force 74 causes the cantilever arm 58 to tilt inwards. This is indicated with dashed arrows 76 in FIGS. 5 and 6. The tilting of the cantilever arm 58 will in turn automatically increase the grip of the catch section on the corrugated tube 28 resulting in the above-mentioned self-locking function.

Located between the anchoring section 36 and the catch section 54, the retention clip 1 comprises a transition section 78. The transition section 78 continuously surrounds the cable channel 12 and is circumferentially monolithic with respect to the insertion direction 16. Herein, the transition section 78 is circumferentially monolithic in that it is uninterrupted and continuous in structure without any breaks, joints, or separable parts along the circumferential direction 50. Not only the transition section 78, but also the catch section 54 and/or the anchoring section 36 may continuously surround the cable channel 12 and be circumferentially monolithic with respect to the insertion direction 16.

This monolithic nature of the transition section 78 brings about the following advantages:

On one hand, the retention clip 1 is easy to manufacture and install compared to existing strain relief structures that normally comprise two halves which need to be manufactured and handled separately. On the other hand, the retention clip 1 is compact in its design, since no hinges or buckles that would hold together the two halves in existing strain relief structures are required.

This all allows the retention clip 1 to be installed easily and quickly.

A further advantage of the retention clip 1 arises from its flexibility during installation. That is, the cable tube 24 can be inserted into the cable channel 12 and engaged by the catch section 54, prior to or after the attachment of the retention clip 1 to the connector housing 42. The order of these work steps can be chosen freely, depending on the application.

Once the catch section 54 engages the cable tube 24 and the retention clip 1 is attached to the connector housing 42 using the anchoring section 36, a mechanical strain relief for the cable tube 24 is completed. Any pull-out force 74 acting on the cable tube 24 is received by the catch section 54, and transmitted via the transition section 78 to the connector housing 42 through the anchoring section 36.

Optionally, the transition section 78 may comprise a stop surface 80 extending perpendicular to the insertion direction 16 and/or facing away from the anchoring section 36. For example, an inner diameter 82 of the cable channel 12 in the region of the transition section 78 is chosen to be smaller than the outer rib diameter 34 of the corrugated tube 28. The difference between the inner diameters 70, 82 is covered by the stop surface 80. Further, the stop surface 80 may be aligned with the protrusion 64 in the insertion direction 16. That is, the stop surface 80 may at least partially overlap with the protrusion 64 in the insertion direction 16. Once the inserted corrugated tube 28 abuts against the stop surface 80, it is not insertable any further (see FIG. 5). This prevents the corrugated tube 28 from sinking too far into the retention clip 1.

Optionally, the at least one latching element 56 may comprise a tool engagement portion 84 adapted for receiving a tool tip (not shown) during removal of the corrugated tube 28. In particular, the tool engagement portion 84 may be located between the cantilever arm 58 and the protrusion 64. There, the tool engagement portion 84 allows the corrugated tube 28 to be released by deflecting the latching element 56 away from and out of engagement with the corrugated tube 28.

For increased stability, the catch section 54 may comprise at least two latching elements 56. As is shown in FIG. 4, the at least two latching elements 56 may be arranged diametrically opposite each other with respect to the cable channel 12. Optionally, more than two latching elements may be provided and distributed circumferentially around the cable channel 12. The cantilever arms 58 of these latching elements 56 may extend in parallel, while their protrusions 64 point towards each other.

Instead of the latching elements 56, the catch section 54 may also comprise one or more friction elements (not shown) protruding into the cable channel. These friction elements may each comprise a roughened surface facing towards the cable channel, which is used for engaging in the above-mentioned force-fit with the cable tube.

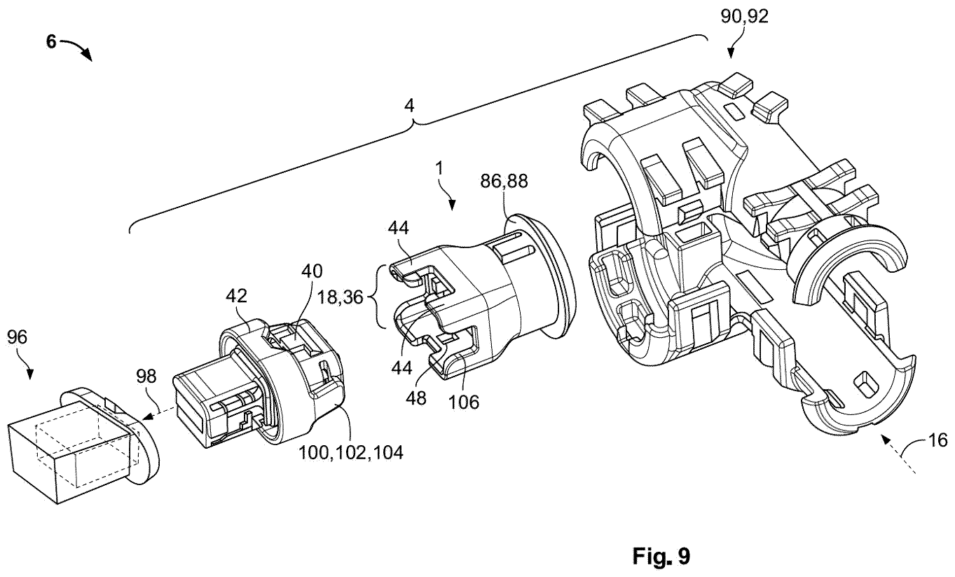

Optionally, the catch section 54 may form a collar 86 with an outward extending flange 88. Said flange 88 increases the structural stability of the catch section 54 through added stiffness, which allows the retention clip 1 to withstand higher pull-out forces 74 before deforming and giving in. If an adjustment of the cable exit direction is required, angled cable routing means 90, such as a 90° elbow 92 can be attached to said flange 88 (see FIG. 9).

As can be seen in FIGS. 5 and 6, the cable assembly 2 comprises the retention clip 1, the cable tube 24 embodied as the corrugated tube 28 and the cable harness 14. The cable harness 14 may comprise multiple cables 94, which are bundled by the cable tube 24 at least partially surrounding the cable harness 14 (see FIG. 5). Alternatively, the cable harness 14 may comprise a single cable 94 requiring additional protection by the cable tube 24 against damage, heat and other kinds of external influences.

The cable harness 14 and the cable tube 24 may both be passed through the cable channel 12 of the retention clip 1. Herein, the cable harness 14 may pass through the entire cable channel 12, while the cable tube 24 at least reaches the catch section 54. As can be seen in FIG. 5, neither the protrusion 64 nor the stop surface 80 hinder the cable harness 14 from passing through the cable channel 12. In other words, only the corrugated tube 28 interferes with the protrusion 64 and stop surface 80.

FIG. 7 shows an exploded view of the connector 4. The connector 4 comprises the cable assembly 2 and the housing 42, wherein the retention clip 1 of the cable assembly 2 is attached to the housing 42 by means of its anchoring section 36 (see FIG. 8). As such, the connector 4 has an improved maintainability, since selective removal of only those components that need to be inspected, repaired or exchanged is possible. For example, the corrugated tube 28 can be released from the catch section 54 (e.g. by deflecting each latching element 56), without having to remove the retention clip 1 from the housing 42. Likewise, the whole cable assembly 2 can be detached from the housing 42 without disengaging the retention clip 1 from the corrugated tube 28.

The connector 4 may be part of the connection assembly 6. In FIG. 9, an exemplary embodiment of the connection assembly 6 is shown comprising the connector 4 and a complementary connector 96. Herein, the complementary connector 96 is configured to be mated with the connector 4 along a mating direction 98. In certain applications, the mating direction 98 may coincide with the insertion direction 16. In other applications, the mating direction 98 may be perpendicular to the insertion direction 16, for example if angled cable routing means 90 are utilized.

Optionally, the connection assembly 6 may comprise a mating aid 100 adapted for supporting a mating process and/or an un-mating process of the connector 4 and complementary connector 96. For example, the mating aid 100 may be a release mechanism 102, such as a button, key or push-area 104, configured to be actuated perpendicular to the mating direction 98.

In the embodiment shown in FIG. 7, the mating aid 100 is configured as a pair of push-areas 104 located on opposite sides of the connector housing 42. These push-areas 104 are meant to be squeezed with the human thumb and index finger, in order to release the connector 4 from the complementary connector 96. As can be seen in FIG. 8, the push-areas 104 at least partially extend through the cable channel 12 of the retention clip 1. In particular, the retention clip 1, specifically the anchoring section 36 may comprise access slots 106 at locations corresponding to the respective push-areas 104. Through these access slots 106, the push-areas 104 are accessible for the squeezing fingers. Alternatively, the access slots may be configured to restrict the push-areas to be actuated only from a certain direction and/or with a certain tool (not shown). Depending on the number, size, shape and location of the push-areas 104, appropriate access slots 106 may be provided at the anchoring section 36 and distributed along the circumferential direction 50 interposed between the snap-fit hooks 44 and snap-fit pockets 48.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. Retention clip for mechanical strain relief of a cable tube surrounding a cable harness of a connector, wherein the retention clip defines a cable channel for passing there-through the cable harness along an insertion direction, wherein the retention clip comprises:
a catch section at least partially projecting into the cable channel and adapted to engage the cable tube inserted into the cable channel;
an anchoring section for attachment of the retention clip to the connector; and
a transition section located between the anchoring section and the catch section;
wherein the transition section continuously surrounds the cable channel and is circumferentially monolithic with respect to the insertion direction.

2. Retention clip according to claim 1, wherein the catch section forms a retention surface extending perpendicular to the insertion direction and facing towards the anchoring section.

3. Retention clip according to claim 1, wherein the catch section forms a lead-in chamfer extending obliquely with respect to the insertion direction and/or facing away from the anchoring section.

4. Retention clip according to claim 1, wherein the catch section comprises at least one latching element configured deflectable away from the cable channel.

5. Retention clip according to claim 4, wherein the at least one latching element comprises a protrusion extending into the cable channel radially with respect to the insertion direction.

6. Retention clip according to claim 4, wherein the at least one latching element comprises a cantilever arm extending along the insertion direction.

7. Retention clip according to claim 6, wherein the cantilever arm comprises a proximal end connected to the rest of the catch section and a distal end forming the protrusion.

8. Retention clip according to claim 7, wherein the anchoring section is closer to the distal end than to the proximal end.

9. Retention clip according to claim 7, wherein the retention surface of the catch section is offset inwards with respect to the proximal end of the cantilever arm.

10. Retention clip according to claim 4, wherein the at least one latching element comprises a tool engagement portion adapted for receiving a tool tip during removal of the cable tube.

11. Retention clip according to claim 4, wherein the catch section comprises at least two latching elements arranged opposite each other with respect to the cable channel.

12. Retention clip according to claim 1, wherein the catch section forms a collar with an outward flange.

13. Cable assembly comprising:
a retention clip including a cable channel extending along an insertion direction, the retention clip includes a catch section at least partially projecting into the cable channel and adapted to engage the cable tube inserted into the cable channel, the retention clip includes an anchoring section for attachment of the retention clip to the connector, the retention clip includes a transition section located between the anchoring section and the catch section, wherein the transition section continuously surrounds the cable channel and is circumferentially monolithic with respect to the insertion direction
a cable tube inserted into the cable channel, wherein the catch section of the retention clip is engaged with the cable tube; and
a cable harness inserted into the cable channel, wherein the cable harness is at least partially surrounded by the cable tube.

14. Cable assembly according to claim 13, wherein the catch section forms a retention surface extending perpendicular to the insertion direction and facing towards the anchoring section.

15. Cable assembly according to claim 13, wherein the catch section forms a lead-in chamfer extending obliquely with respect to the insertion direction and/or facing away from the anchoring section.

16. Cable assembly according to claim 13, wherein the catch section comprises at least one latching element configured deflectable away from the cable channel.

17. Connector comprising:
a cable assembly and a housing holding the cable assembly
wherein the cable assembly includes a retention clip including a cable channel extending along an insertion direction, the retention clip includes a catch section at least partially projecting into the cable channel and adapted to engage the cable tube inserted into the cable channel, the retention clip includes an anchoring section for attachment of the retention clip to the connector, the retention clip includes a transition section located between the anchoring section and the catch section, wherein the transition section continuously surrounds the cable channel and is circumferentially monolithic with respect to the insertion direction
wherein the cable assembly includes a cable tube inserted into the cable channel, wherein the catch section of the retention clip is engaged with the cable tube; and
wherein the cable assembly includes a cable harness inserted into the cable channel, wherein the cable harness is at least partially surrounded by the cable tube, and
wherein the retention clip is attached to the housing by the anchoring section.

18. Connector according to claim 17, wherein the catch section forms a retention surface extending perpendicular to the insertion direction and facing towards the anchoring section.

19. Connector according to claim 17, wherein the catch section forms a lead-in chamfer extending obliquely with respect to the insertion direction and/or facing away from the anchoring section.

20. Connector according to claim 17, wherein the catch section comprises at least one latching element configured deflectable away from the cable channel.
